(19) United States
(12) Patent Application Publication
(10) Pub. No.: US 2003/0037133 A1
(43) Pub. Date: Feb. 20, 2003

(54) Method and system for implementing redundant servers

(76) Inventor: Thomas Owens, Portage, MI (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/022,574

(22) Filed: Dec. 20, 2001

Related U.S. Application Data
(60) Provisional application No. 60/312,596, filed on Aug. 15, 2001.

(51) Int. Cl. G06F 15/173; G06F 15/16

(52) U.S. Cl. 709/223; 709/203

(57) ABSTRACT

A method for providing a backup server to a primary server includes operating a first server such that the first server communicates with a network and is associated with a primary server address. A second server is also maintained, configured in parallel with the first server, and associated with a monitor server address. The monitor server includes periodically signaling the primary server address, watching to determine whether a response to the signal is received within a predetermined time period, and repeating the signaling and watching until a time period elapses where the response is not received within the time period. If a response is not received, the first server is rebooted and the second server assumes the role of the primary server.

### FIELD OF THE INVENTION

The present invention relates generally to computer system operating applications. More particularly, the present invention relates to a method and system for implementing redundant computer servers such that a backup server is automatically brought on line if a primary server should fail.

### BACKGROUND OF THE INVENTION

Client/server computing involves a software architecture in which remote and/or user computing devices contain software applications, referred to as “clients”, that request service from one or more central computing devices, referred to as “servers.” Client/server computing provides efficient use of computer resources, as the server may include processing capability and memory to house and run one or more software applications or portions of software applications. The server may also be used as a central storage device, or to manage one or more other central storage devices. In a client/server environment, because applications and/or files are maintained and/or processed by the server, the client workstations need not contain the processing and/or memory capacity to allow them to run all applications and store all files. Thus, the client workstations can be relatively low-cost devices with little processing or storage capacity when compared to that of the server. The server can, therefore, house data, run programs or portions of programs, and perform other services requested by the clients. The server may also manage shared resources such as databases, printers, communication links, or other devices.

A limitation of client/server architecture is that when a server malfunctions, loses power, breaks down, or otherwise fails to process client requests, the effects are great because a large number of client workstations may rely on the server. Thus, if a server goes down, client workstations can lose their ability to access shared resources such as applications, data files, printers, and communication links. In addition, many users and active applications can lose their data and other features when a server goes down, as the server is not there to receive data or store the features when sent to the server by the client.

Professionals in the field have attempted to limit the problem of server failure by providing a primary server, which is normally on-line, and a backup server, which is brought on-line if the primary server should fail. However, the process of identifying a primary server failure and bringing a backup server on-line is still typically a manual process. Thus, several minutes or more can elapse during the time that a server failure is identified, appropriate personnel are alerted, and a backup server is started and brought on-line. During this period, valuable data, application settings, and other features can be lost. This also requires costly 24 hour a day, 7 day per week on-site support and monitoring.

Thus, if an efficient, low-cost application for automatically bring a backup server on-line when a primary server failed, companies could avoid the tremendous costs that may result from loss of data and other information due to server failure.

Accordingly, it is desirable to provide an improved method and system for ensuring computer reliability that automatically switches between primary and backup servers.

### SUMMARY OF THE INVENTION

It is therefore a feature and advantage of the present invention to provide an improved method and system for ensuring computer reliability that automatically switches between primary and backup servers.

The above and other features and advantages are achieved through the use of a novel server failure protection method and system as herein disclosed. The method for providing a backup server to a primary server disclosed herein includes operating a first server such that the first server communicates with a network and is associated with a primary server address. A second server is also maintained, configured in parallel with the first server, and associated with a monitor server address. The monitor server includes periodically signaling the primary server address, watching to determine whether a response to the signal is received within a predetermined time period, and repeating the signaling and watching until a time period elapses where the response is not received within the time period. If a response is not received, the first server is rebooted and the second server assumes the role of the primary server.

In accordance with a preferred embodiment of the present invention, a method for providing backup server support includes the steps of: (1) operating a first server wherein the first server is capable of communication with a network and is associated with a primary server address; (2) maintaining a second server wherein the second server is capable of communication with the network, configured in parallel with the first server, and is associated with a monitor server address; (3) signaling, using a first signal, the primary server address; (4) monitoring for a response to the first signal within a predetermined time period; and (5) repeating the signaling step and the monitoring step until a time period elapses wherein the response is not received within the time period, and thereafter performing the step of booting the first server.

Optionally, the first server includes a first server memory and the second server includes a second server memory, and the method includes the additional step of, after the signaling step is repeated a predetermined number of times, copying data from the first server memory to the second server memory. Also optionally, the method includes the additional step of, in conjunction with the booting of the first server, operating the second server. This second operating step comprises providing server services to the network.

Also optionally, the operating step may comprise providing server services to the network. Also optionally, the maintaining step may comprise maintaining the second server in a backup mode so that the second server can be associated with the primary server address when a time period elapses wherein the response is not received within the time period. Also optionally, the primary server address is an Internet protocol address. Optionally and preferably, the signaling step comprises pinging the primary server address.

As an additional option, the response to the first signal in the time period is indicative of operation of the first server as the primary server, and an absence of the response to the first signal in the time period is indicative of primary server malfunction or inactivity.

Further, the method may include the additional steps of, in conjunction with the booting of the first server: (1) signaling, using a second signal, the monitor server address; and (2) monitoring for a response to the second signal within a second time period. In this option, if a response to the second signal is received within the secondary time period, the second server is operated as a monitor server. If a response to the second signal is not received within the second time period, the second server is thereafter operated as a primary server.

In accordance with an alternate embodiment, a system for operating redundant computers includes a carrier containing computer program instructions thereon, wherein the instructions instruct a computer processor to perform an or all of the steps described above.

There have thus been outlined the more important features of the invention in order that the detailed description thereof that follows may be better understood, and in order that the present contribution to the art may be better appreciated. There are, of course, additional features of the invention that will be described below and which will form at least part of the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting in any way.

As such, those skilled in the art will appreciate that the concept and objectives, upon which this disclosure is based, may be readily utilized as a basis for the design of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram illustrating several exemplary steps of the present inventive method.

FIG. 2 is a block diagram illustrating several additional exemplary steps of the present inventive method.

FIG. 3 is a block diagram of several exemplary elements of the present inventive system.

### DETAILED DESCRIPTION OF PREFERRED EMBODIMENTS OF THE INVENTION

In a preferred embodiment of the present invention, a primary computer server and a secondary, or monitor, computer server are connected in parallel to a network. Each server may be any type of server containing processing capability and memory. Optionally, more than two servers may be used, in which case multiple backup servers will be available. The invention includes a method and system for automatically implementing a backup server if the primary server should malfunction, lose power, lose a communication link with the network, or otherwise fail.

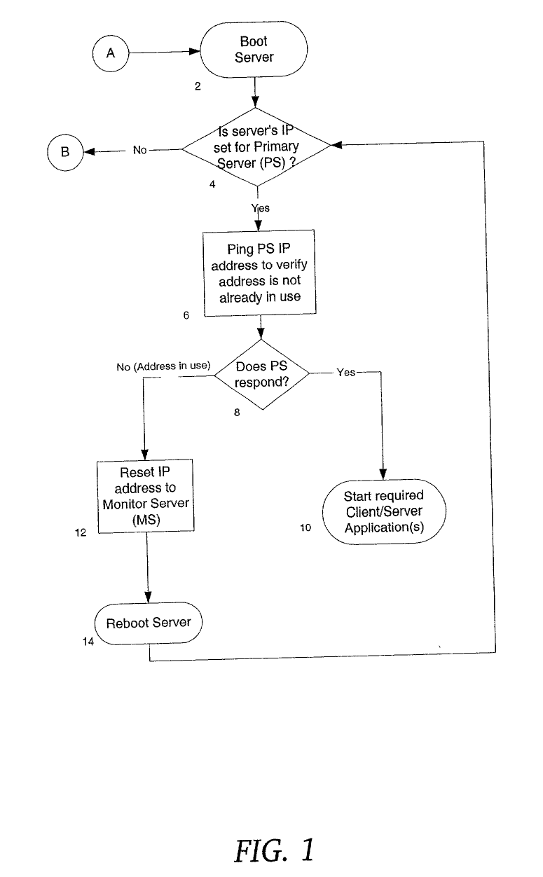

A preferred embodiment of the present inventive method is illustrated in FIG. 1. FIG. 1 contemplates an arrangement whereby a primary computing device, referred to in the appended drawings as a primary server, or PS, is in communication with a network, such as a local area network (LAN), wide area network (WAN), a global communications network such as the Internet, or another network. The connection may be any communicative link, such as one or more direct wires or cables, a wireless connection, or a combination of both wireless and wired links. A backup computing device or server, referred to in the drawings as a monitor server, or MS, is also provided. Optionally, additional backup servers may be used, with each backup server to which the method applies being configured to be connected to the network or in communication with the network in parallel with the primary server. An address is assigned to each server and may be used to direct the selection of the primary server or the monitor server. The address is preferably an Internet protocol (IP) address, although optionally it may be any other address such as a network address.

Referring to FIG. 1, the method begins by starting, or booting, a first server (step 2). The method includes checking a network address to determine whether the first server's address is set for the primary server or the monitor server (step 4). As with the server addresses, the network address is also preferably an IP address, although any applicable address may be used.

If the first server's address is set for the primary server address, as would be the case under normal operation or at times such as the initialization of the first server, a signal is sent to the primary sever address to verify that the address is already not in use (step 6). Preferably, the signal is of a type that checks for the presence of the primary server address and waits for a response. Such a signal is commonly referred to as a “ping,” as it may be generated by a basic Internet “ping” utility, although other utilities that send a signal and check for a response may be used. The ping utility confirms that the computing device that the system is trying to signal is actually operating. A response to the signal indicates that the first server is acting as the primary server. The absence of a response indicates that the first server is unable to communicate with itself because the primary server IP address is already in use by another server.

The system checks to see if the primary server responds to the ping (step 8). If a response is received, primary server operation by the first server is established (step 10). This operation may include the primary server's supplying any type of services to its clients, such as web services, printing services, storage services, and/or processing services.

Conversely, if the primary server does not respond to the ping in step 8, it can be assumed that another server is already acting as the primary server, and the first server's address is reset to that of the monitor server (step 12), and the first server is rebooted (step 14). Thereafter, the method returns to checking whether the first server's address is set for the primary server (step 4). In this case, because a primary server has already been detected and the network address has been reset for the monitor server, the system proceeds to attempt to operate the first server as the monitor server.

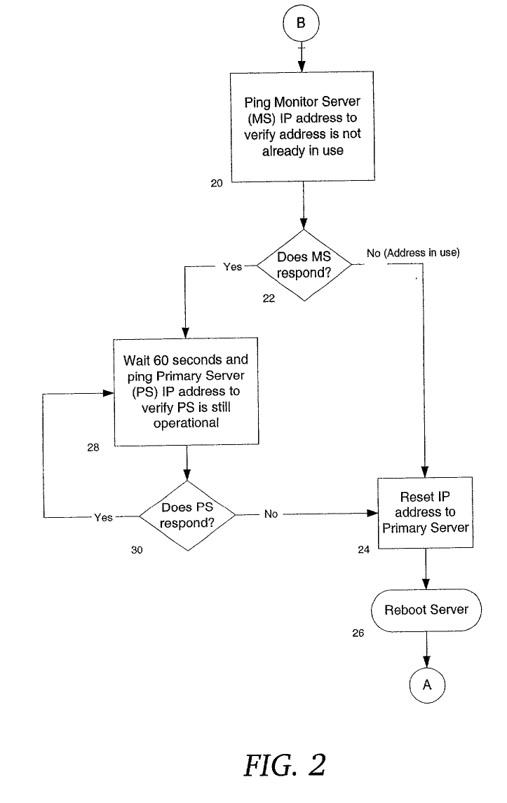

An exemplary method of operating a server as the monitor server in conjunction with the primary server is illustrated in FIG. 2. Referring to FIG. 2, when the monitor server function is started, the system signals the monitor server address (step 20) to verify that the address is not already in use. Again, the signaling is preferably performed using the ping utility, and the method checks for the presence of the monitor server and waits for a response (step 22). If a response to the ping is received, the server is confirmed to be operational as the monitor server and is brought into service for the network. The role of the monitor server is to periodically “ping” or otherwise signal the primary server address to verify that the primary server is still operational. Additional operations can also be performed, such as copying key files from the primary server to the monitor server to keep data on both servers synchronized. If a response is not received in step 30, the network address is reset to the primary server address (step 24), the server is rebooted (step 26), and the primary server is brought back on line as illustrated in FIG. 1.

If a response is not received in step 22, it can be assumed that a monitor server is already operational and the server's network address is reset to the primary server address (step 24), the server that was previously acting as the primary server is rebooted (step 26), and the server that was previously acting as the monitor server will attempt to operate as the primary server as in FIG. 1.

Optionally, one or more additional backup or monitor servers may be used. In the event that both a primary and monitor server are operational, any additional servers added to the system will operate in a continuous loop of setting their IP address for a primary server but detecting a existing primary server, setting their IP address for a monitor server and rebooting but then also detecting an existing monitor server, setting their IP address back for a primary server and rebooting, etc. (as illustrated in FIGS. 1 and 2). In such a situation, if a primary server fails and a monitor server gets “promoted” to the role of the primary server, one of these additional servers will then take on the role of a monitor server for the new primary server.

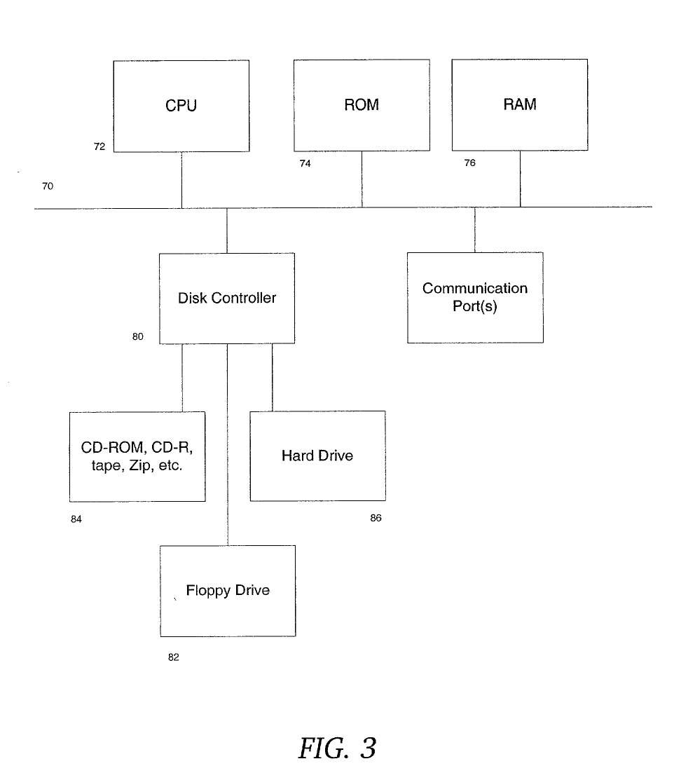

FIG. 3 is a block diagram illustrating the exemplary components of an exemplary computing device that may act as a server in accordance with the present inventive system. Referring to FIG. 2, a bus 70 serves as the main information highway interconnecting the other components of the computer. CPU 72 is the central processing unit of the system, performing calculations and logic operations required to execute a program. Memory, preferably including both read only memory (ROM) 74 and random access memory (RAM) 76, constitutes the main memory of the server.

Communication with external devices and the computer network may optionally occur using various communication ports such as 78. Either a single communication port or multiple communication ports may be provided.

Optionally, a disk controller 80 may interface one or more disk drives to the system bus 70. These disk drives may be external or internal floppy disk drives such as 82, external or internal CD-ROM, CD-R, CD-RW or DVD drives such as 84, or external or internal hard drives 86. As indicated previously, these various disk drives and disk controllers are optional devices.

Program instructions may be stored in a memory carrier such as the ROM 74 and/or the RAM 76. Optionally, program instructions may be stored on any other computer readable carrier such as a floppy disk, a digital disk or other recording medium, a communications signal, or a carrier wave.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, all of which may fall within the scope of the invention.

What is claimed is:

1. A method for providing backup server support, comprising:
operating a first server wherein the first server is capable of communication with a network and is associated with a primary server address;
maintaining a second server wherein the second server is capable of communication with the network, configured in parallel with the first server, and is associated with a monitor server address;
signaling, using a first signal, the primary server address;
monitoring for a response to the first signal within a predetermined time period; and
repeating the signaling step and the monitoring step until a time period elapses wherein the response is not received within the time period, and thereafter performing the step of booting the first server.

2. The method of claim 1 wherein the first server includes a first server memory and the second server includes a second server memory, and comprising the additional step of, after the signaling step is repeated a predetermined number of times, copying data from the first server memory to the second server memory.

3. The method of claim 1 comprising the additional step of, in conjunction with the booting of the first server, operating the second server.

4. The method of claim 1 wherein the operating step comprises providing server services to the network.

5. The method of claim 3 wherein the second operating step comprises providing server services to the network.

6. The method of claim 1 wherein the maintaining step comprises maintaining the second server in a backup mode so that the second server can be associated with the primary server address when a time period elapses wherein the response is not received within the time period.

7. The method of claim 1 wherein the primary server address is an Internet protocol address.

8. The method of claim 1 wherein the signaling step comprises pinging the primary server address.

9. The method of claim 1 wherein the response to the first signal in the time period is indicative of operation of the first server as the primary server, and an absence of the response to the first signal in the time period is indicative of primary server malfunction or inactivity.

10. The method of claim 1 comprising the additional steps of, in conjunction with the booting of the first server:
signaling, using a second signal, the monitor server address; and
monitoring for a response to the second signal within a second time period.

11. The method of claim 10 wherein a response to the second signal is received within the secondary time period, and the second server is operated as a monitor server.

12. The method of claim 10 wherein a response to the second signal is not received within the second time period, and the second server is thereafter operated as a primary server.

13. A system for operating redundant computers comprising:
a carrier containing computer program instructions thereon, wherein the instructions instruct a computer processor to perform the steps of:
signaling, using a signal, a primary server address;
monitoring for a response to the signal within a predetermined time period; and
repeating the signaling step and the monitoring step until a time period elapses wherein the response is not received within the time period, and thereafter performing the step of booting a first server.

14. The system of claim 13 wherein the instructions also instruct the processor to perform the additional step of, after the signaling step is repeated a predetermined number of times, copying data from a first server memory to a second server memory.

15. The system of claim 13 wherein the instructions also instruct the processor to perform the additional step of, in conjunction with the booting of the first server, operating a second server.

16. The system of claim 13 wherein the instructions also instruct the processor to maintain the second server in a backup mode so that operation of the second server can be provided when a time period elapses wherein the response is not received within the time period.

17. The system of claim 13 wherein the primary server address is an Internet protocol address.

18. The system of claim 13 wherein the response to the signal in the time period is indicative of primary server operation, and an absence of the response to the signal in the time period is indicative of primary server malfunction or inactivity.

19. The system of claim 13 further comprising:
a first computing apparatus including a first memory, the first computer apparatus being communicatively connected to a network and corresponding to the primary server address;
a second computing apparatus including a second memory, the second computing apparatus in communication with the network, configured in parallel with the first computing apparatus, and having a secondary server address; and
a processor.

20. A redundant computer system comprising:
a first computing apparatus communicatively connected to a network and corresponding to a primary server address;
a second computing apparatus in communication with the network and configured in parallel with the first computing apparatus, and associated with monitor server address;
a means for signaling the primary server address;
a means for monitoring for a response to the signal within a predetermined time period; and
a means for repeating the signaling step and the monitoring step until a time period elapses wherein the response is not received within the time period; and a means for booting the first server.
